(19) United States
(12) Patent Application Publication
(10) Pub. No.: US 2010/0112883 A1
(43) Pub. Date: May 6, 2010

(54) DIARYL UREA FOR TREATING INFLAMMATORY SKIN. EYE AND/OR EAR DISEASES

(75) Inventors: Yves Giraud, Sainte Foy Les Lyon (FR); Martial Deruelle, Mornant (FR); Geoffray Meffre, Lyon (FR)

Correspondence Address: Baker Donelson Bearman, Caldwell & Berkowitz, PC, 555 Eleventh Street, NW, Sixth Floor, Washington, DC, 20004, US

(73) Assignee: Rhodia Recherches Et technologies, Aubervillers (FR)

(21) Appl. No.: 12/097,973

(22) PCT Filed: Dec. 19, 2006
(86) PCT No.: PCT/EP06/69891

§ 371 Date: Nov. 3, 2008

(30) Foreign Application Priority Data
Dec. 19, 2005 (FR) 0512884

(51) Int. Cl. B32B 5/02; B05D 3/02; B05C 1/04; B05C 9/14

(52) U.S. Cl. 442/59; 427/372.2; 118/696; 118/58

(57) ABSTRACT

The present invention relates to pharmaceutical compositions for treating inflammatory skin, eye and/or ear diseases comprising 4{4-[3-(4-chloro-3-trifluoromethylphenyl)-ureido]-3-fluorophen-oxy}-pyridine-2-carboxylic acid methylamide optionally combined with at least one additional therapeutic agent.

The present invention relates to a process for impregnating a textile surface, according to which the textile surface is brought into contact with at least one fixed, hollow cylinder that dispenses an impregnating liquid by means of orifices, present on the contact surface between the cylinder and the textile surface, so as to impregnate said textile surface on one of its faces. The process of the invention thus makes it possible to impregnate a textile surface in a controlled, precise and productive manner.

### PRIOR ART

Numerous techniques exist that may be used to impregnate a textile surface with a fluid treatment. The most widespread technique is that of pad finishing, which consists globally in passing the textile surface through a bath containing the fluid impregnation product, then in expressing the excess fluid absorbed by applying a pressure between two expressing rolls, or drain rolls, and finally in passing through a drying oven. Specifically, when the textile surface is treated with a formulation comprising an organic solvent or diluent, it is desirable subsequently to remove the diluent or solvent, for example to subject this article to a heat treatment to strip off the diluent or solvent in the form of vapor. FIG. 1 shows one of the variants of this very widespread technique.

This technique, which is very useful, in the general case of treating a simple textile surface with an unreactive product, nevertheless involves numerous limitations liable to limit the efficacy and precision of the treatment. The following points will be noted in particular:
it is particularly unsuitable for impregnation products that are sensitive on contact with the surrounding atmosphere, such as moisture or oxygen, since the surface of the bath is permanently exposed, as is the excess product that falls back into the bath with regularity, exposing a large area to the ambient air;
it does not offer precise control of the amount deposited during the process, since phenomena modifying the concentration of the bath may take place: evaporation of the solvent at the surface of the bath and on return of the expressing rolls. Wetting and capillarity may also have an impact on the amounts of products entrained by the textile during its passage through the bath;
in terms of industrial safety and hygiene, the use of products in solvent phase entails the presence of large evaporation surfaces, and complex and expensive devices are necessary to channel the resulting solvent-laden atmospheres;
contamination of the bath with residues from the textile surface is also a common problem that is detrimental to the quality of the impregnation;
as a result of the turbulence caused by the various movements of the fluid to be impregnated, there is frequently formation of foam, which is detrimental to the functioning of the installation and occasionally to the appearance of the finished article;
it is not suitable either when it is desired to impregnate only one face of the textile to be treated, which constitutes an increasingly common case in the profession with laminated fabrics and multilayer articles.

Another technique exists for impregnating a complex textile surface on only one face, and is known as kiss roll impregnation. This consists in passing the textile surface in contact with a roll that rotates in the bath and becomes impregnated with product, which it then transfers onto the textile surface. As previously, the textile surface is then conveyed through a drying oven. FIG. 2 illustrates one of the variants of this impregnation technique.

This technique, which is pertinent in a certain number of cases for treating a textile on only one face, proves to be entirely unsuitable in the following cases:
when the viscosity of the impregnation product is really very low, the amount picked up by the kiss roll is also low and it is occasionally impossible to compensate by the differential rotation speed of this roll to bring the desired amount of impregnant onto the textile surface. This is particularly true when it is desired truly to achieve deep-down impregnation of the textile and, in this case, a low viscosity is recommended;
the handling of an impregnation product that is reactive with respect to the surrounding atmosphere is recommended just as little as in the case of pad finishing, especially on account of the exposure of the bath and of the transfer of a thin layer of product onto the roll;
contamination of the bath is a less serious problem than in the case of pad finishing, but may nevertheless occur;
this technique requires relatively limited textile throughput speeds, thus limiting the productivity of the treatment line;
in this case also, foaming is liable to occur and to give rise to problems of quality of the treated textile surface;
depending on the impregnating liquids used, especially those that crosslink or react on contact with air, the kiss roll will have a tendency to become fouled and to give rise to marks on the textile surface.

There is thus a real need to develop an industrially viable textile surface impregnation process that avoids the drawbacks mentioned previously.

### INVENTION

In order to solve the stated problem, the Applicant has developed a technique that is particularly suitable for impregnating one of the faces of a complex textile surface with a fluid product, which is especially reactive or which shows sensitivity to the surrounding atmosphere.

This technique is based on the use of a perforated kiss roll that is fixed, i.e. that does not rotate, which dispenses by means of an array of orifices arranged on one or more generatrices of the roll the appropriate amount of impregnating liquid directly onto one of the faces of the textile surface.

The advantages of this technique are as follows:
the impregnation product may be applied in a quantitatively controlled manner to one of the faces of a complex textile. To do this, it suffices to control the throughput speed of the textile surface, the flow rate of the impregnating liquid onto the textile surface, and the position and geometry of the perforated hollow cylinder, such as the position and diameter of the distribution orifices. Adaptation of these parameters makes it possible especially to be able to use the process of the invention irrespective of the nature of the impregnating fluid and of the amount to be dispensed per unit area;
the process generates little or no foam;
the viscosity of the impregnating liquid may be very low, thus facilitating penetration down to the core of the textile structure;
the impregnation product is never exposed to the surrounding atmosphere before final application to the textile surface;
there is no risk of contamination of the impregnation product with impurities arising from the textile surface;
the productivity of this technique is excellent, since it suffices to dispense the desired dose of impregnation product and optionally to force the penetration into the textile surface with the aid of doctor blades or cylinders, or any other optional device for forcing penetration into the textile structure;
from a hygiene and safety viewpoint, the emanations of solvent, in the case of a product presented in organic solvent phase, are limited in the atmosphere;
finally, the concentration of the impregnation product is always optimal since it is deposited directly.

Thus, the process of the invention makes it possible to perform impregnation on a textile surface in a controlled, precise and productive manner.

### FIGURES

FIG. 1 shows an example of a process for the pad finishing of a textile surface according to the prior art. The textile surface 1 is brought into a bath 2 containing an impregnating fluid in a first stage, and then passes via drain rolls 9, before passing through a drying oven 3 in which the solvent is extracted.

FIG. 2 shows an example of a process for the kiss roll impregnation of a textile surface according to the prior art. The textile surface 1 comes into contact with a roll 4 which rotates in the bath 2 and becomes impregnated with product, which it then transfers onto the textile surface. As previously, the textile surface is then conveyed to a drain roll 9, before passing through a drying oven 3.

FIG. 3 shows an example of a process for treating a textile surface by impregnation according to the invention. The textile surface 1 comes into contact with a perforated cylinder 5, which impregnates said surface with product, the position of the holes relative to the textile or to the vertical being able to be optimized as a function of the nature of the textile or of the solution, for example. The textile surface then passes under a doctor blade 6, which forces the penetration of the product into the textile structure. Finally, the textile surface is then conveyed through a drying oven 3. The perforated cylinder 5 is fed with product via a reservoir 8 by means of a pump 7.

FIG. 4 shows an example of a process for treating a textile surface by impregnation according to the invention. The textile surface 1 comes into contact with a perforated cylinder 5, which impregnates said surface with product. The textile surface than passes between two pressing rolls 9, which force the penetration of the product into the textile structure. Finally, the textile surface is then conveyed through a drying oven 3. The perforated cylinder 5 is fed with product via a reservoir 8 by means of a pump 7.

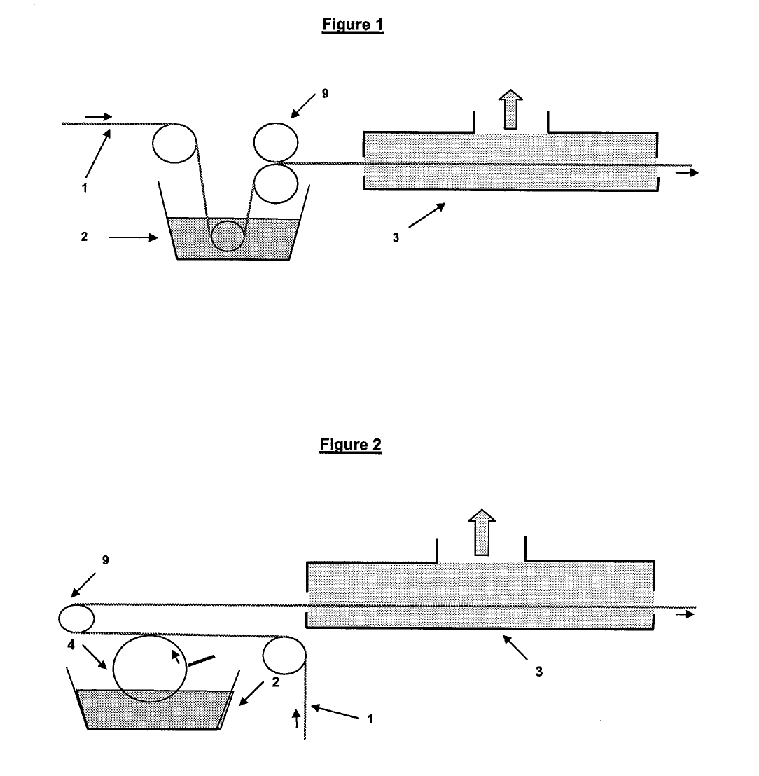

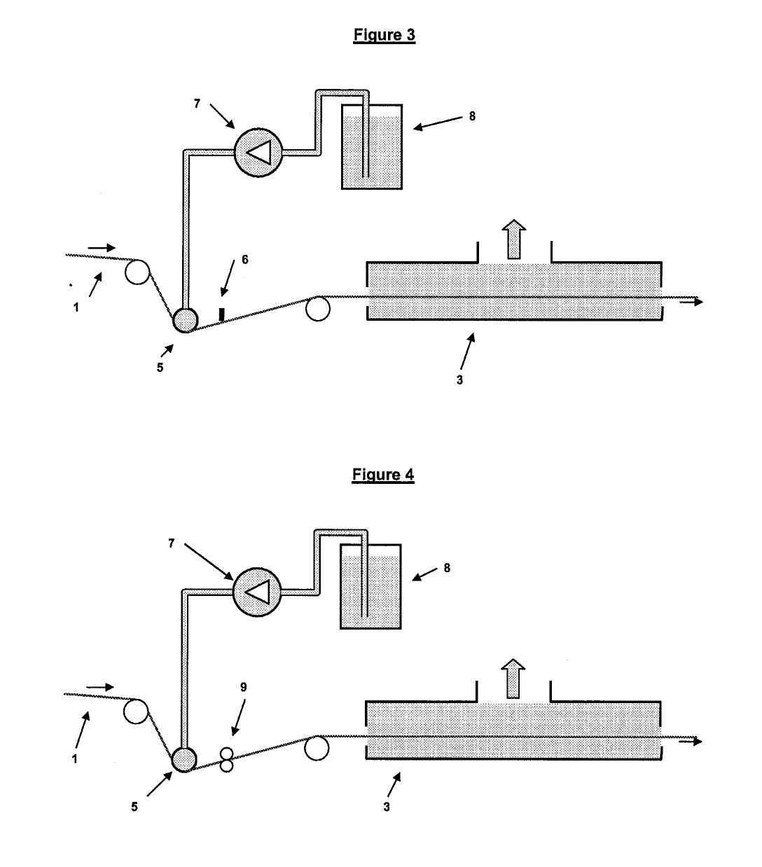

### DETAILED DESCRIPTION OF THE INVENTION

A first subject of the present invention is a process for impregnating a textile surface, in which the textile surface is brought into contact with at least one fixed, hollow cylinder that dispenses an impregnating liquid by means of orifices, present on the contact surface between the cylinder and the textile surface, so as to impregnate said textile surface on one of its faces.

According to the invention, the cylinder is hollow and comprises the impregnating liquid in its interior. As explained below, the cylinder may be fed with impregnating liquid in various ways. According to the invention, the cylinder is fixed in the process defined previously. The fact that the cylinder is not a roll or an object placed in rotation makes it possible to prevent certain impregnating liquids that crosslink or react in the presence of air from fouling the entire surface of said cylinder and thus giving rise to marks and soiling on the textile surface.

The process according to the invention may be performed in continuous or batch mode. The means for bringing the textile surface to the perforated hollow cylinder and optionally toward other finishing steps are those conventionally used in the field, such as those used in the pad finishing process, for instance rolls.

For the purposes of the invention, the term “textile surface” is a generic term including all textile structures. The textile surfaces may be constituted by any textile fiber, yarn, filament and/or other material. They especially include supple fabrics, whether they are woven, bonded, knitted, braided, felt, needle-worked, sewn, or made by another manufacturing method. In the technical field of textiles, the word cloth is also used to denote textile surfaces.

The term “yarn” means, for example, a continuous multifilament object, a continuous yarn obtained by assembling several yarns or a spun yarn of continuous fibers, obtained from fibers of a single type or from a mixture of fibers. The term “fiber” means, for example, a short or long fiber, a fiber intended to be spin-worked or for the manufacture of nonwoven articles or a cable intended to be chopped to form short fibers.

It is entirely possible for the textile surface to be constituted of yarns, fibers and/or filaments that have undergone one or more treatment steps before preparing the textile surface, for instance texturizing, stretching, stretching-texturizing, sizing, relaxing, hot-bonding, twisting, fixing, creping, washing and/or dyeing steps.

According to the invention, any type of textile material may be used for the manufacture of the textile surfaces. As a guide, mention may be made of:
natural textiles, such as: textiles of plant origin, for instance cotton, linen, hemp, jute, coconut, paper cellulose fibers; and textiles of animal origin, such as wool, fur, leather and silks;
artificial textiles, such as: cellulose-based textiles, such as cellulose or derivatives thereof; and protein textiles of animal or plant origin; and
synthetic textiles, such as polyester, polyamide, polymallic alcohols, polyvinyl chloride, polyacrylonitrile, polyolefins, acrylonitrile, (meth)acrylate-butadiene-styrene copolymers and polyurethane.

The synthetic textiles obtained by polymerization or polycondensation may especially comprise in their matrix various types of additives, such as pigments, deluster agents, matting agents, catalysts, heat and/or light stabilizers, antistatic agents, flame retardants, and antibacterial, antifungal and/or anti-acarian agents.

As types of textile surface, mention may be made especially of the surfaces obtained by rectilinear intercrossing of the yarns or fabrics, the surfaces obtained by curvilinear enmeshing of yarns or knits, mixtilinear surfaces or tulles, nonwoven surfaces and composite surfaces. Among the multitude of possible textile surfaces that may be used in the process of the invention, mention may be made of felts, denims, jacquard wovens, needle-worked fabrics, sewn fabrics, crocheted fabrics, grenadines, pinked fabrics, damasks, voile fabrics, alpaca fabrics, barathea fabrics, dimity fabrics, looped fabrics, brocades, calicos, velvets, canvases, chiffons, flocked fabrics, sized fabrics, buntings, braided fabrics, fulles, foulards, cheesecloths, geotextiles, jaspe fabrics, matelasses, tufteds, organzas, pleated fabrics, ribbons and toiles.

The textile surface used in the process of the present invention may be constituted of one or more identical or different textile surfaces, assembled in various ways. The textile surface may be a monolayer or multilayer surface.

The textile surface may be constituted, for example, by a multilayer structure that may be prepared by various assembling means, such as mechanical means, for instance sewing, welding or bonding in spots or continuously.

The structures may comprise at least two textile surfaces, especially those defined previously. Mention may be made, for example, of laminates prepared by bonding a microporous membrane made of PTFE, polyurethane or polyester, especially, between two textile layers; or alternatively laminates made by coating (polyurethane, silicone or the like) inserted between two textile layers.

According to the process of the present invention, the textile surface is brought into contact with a fixed hollow cylinder comprising perforations in the region of contact with said textile surface.

The cylinder of the invention may be constituted by a wide variety of possible materials. It should be noted that the choice of a material for making said cylinder according to the invention is generally guided by cost and property criteria, depending on the applications. Thus, depending on the use that will be made of an object and the environment in which it will be used, different properties will be demanded, such as abrasion resistance, resilience, rigidity, flexibility, size stability, deformation temperature under load, heat resistance, impermeability to certain chemical substances, resistance to the contact of certain substances, etc. Preferentially, the cylinder may be constituted especially by one or more materials preferentially chosen from the group comprising: metal, glass, wood, thermoplastics, thermosetting materials, and mixtures and/or assemblies thereof.

For the purposes of the invention, it is entirely possible for the cylinder to have a totally cylindrical appearance or a different appearance provided that the contact surface between the textile surface and the region dispensing the impregnating liquid via the orifices has a rounded convex shape, so as not to damage the textile surface during its throughput. Said contact surface may have a semicircular or U-shaped cross section, for example. The rest of the cylinder, i.e. other than said contact surface, may have a cross section having a flat and/or curved profile, for instance U-shaped, V-shaped, semicircular, rectangular with straight and/or rounded angles, concave and/or convex. This cylinder may thus have flat regions and/or regions comprising curves. Finally, the cylinder may have a more or less complex structure, for example with spaces for housing other components, reinforcing grooves, means for assembly with other components or component systems.

The cylinder used in the process of the invention may especially be defined by its length and its diameter. As regards the length, it will be chosen to take account of the dimensions, especially the width, of the textile surface to be impregnated. A cylinder having an length adaptable, for example, by sliding different sections, may especially be used. As regards the diameter, account will need to be taken of the type of textile surface used, the desired contact surface between the cylinder and the textile surface, and the type and amount of impregnating liquid used in the process. The cylinder may have, for example, a diameter of between 5 and 200 mm and preferentially between 10 and 100 mm.

As explained previously, the cylinder comprises orifices in the region of contact with said textile surface. It is thus understood that the cylinder preferentially does not comprise orifices outside this contact region so as not to dispense, and thus lose, impregnating liquid in the device.

The mean diameter of the orifices of the perforated cylinder may especially be between 0.05 and 5 mm and preferentially from 0.1 to 1 mm. It should be noted that the perforated cylinder may quite entirely include orifices of identical or different diameters.

The orifices may be arranged in various ways on the contact surface of the cylinder in contact with the textile surface, for example randomly, in one or more parallel lines over the length of the cylinder, or alternatively in zig zags. It should be noted that different geometries may be envisioned as a function of the nature of the textile to be treated. It may also be envisioned to perform batch impregnations by limiting the distribution orifices in certain regions of the textile surface.

Preferentially, the space between the orifices of the cylinder is such that total impregnation of the textile surface may be obtained when it passes over the contact surface of the cylinder, taking into account especially the diffusability of the impregnating liquid on the textile surface.

Even more preferentially, the spacing and positioning of the cylinder orifices may obey the following relationship: 0.1≦L≦10, and more preferentially 0.5≦L≦2, with L corresponding to the ratio between the total theoretical length of the orifices arranged next to each other over the length of the cylinder; and the length of the cylinder. It should be noted that L may be greater than 1, especially when the orifices are arranged in zig zags on the contact surface of the cylinder.

The cylinder may be perforated by various processes that are well known to those skilled in the art. The cylinder may be perforated, for example, by laser, by electro-erosion, by punching, especially hot punching, for example using needles, or alternatively by drilling, especially using a drill bit.

Preferentially, the process of the invention comprises a means for bringing the impregnating liquid into the perforated hollow cylinder. This means may especially be a pump that draws the liquid from a reservoir and brings it to said cylinder. This means may also be a device allowing the liquid to be brought by gravity from the reservoir to the cylinder, or alternatively a device according to which a pressure exerted on the reservoir allows the liquid to be brought from the reservoir to the cylinder.

The process according to the invention is directed toward treatment by impregnating a textile surface. It is entirely possible to use any type of impregnating liquid for impregnating the textile surface according to the invention. By way of nonlimiting example, the impregnating liquid may comprise one or more agents of interest chosen from the group comprising:
dyeing agents, such as dyes and pigments,
bleaching agents, such as hydrogen peroxide and, more generally, any peroxide or persalt used in this field,
glazing agents, such as starch,
mercerizing agents, such as sodium hydroxide,
impermeabilizing and water-repellent agents, such as paraffins, fluoro resins and silicone resins, for example in solvent or aqueous medium,
flame retardants, such as the phosphorus compounds used in the flame retardancy of cotton, for example,
stain removers, for instance fluoro compounds,
antibacterial, antifungal and/or anti-acarian agents,
water-repellency agents, such as paraffins and silicone and fluoro resins. Water repellency is a characteristic of the surface of the textile. It corresponds to the fact that, under moderate moistening, representative of light rainfall, there is little or no adhesion of the water to the textile,
softeners such as cationic softeners or silicone softeners.

The impregnating liquid may have a dynamic viscosity of between 0.1 and 1000 and even more preferentially between 0.5 and 50, measured using a Couette viscometer or a capillary viscometer.

The liquid compositions that may be used according to the invention may especially comprise:
organic compounds, such as optionally fluorinated acrylates, or waxes;
silicone-based compounds, such as silicone oils, which are especially functionalized (for example with amine, amide, polyether, fluoro, epoxy, hydroxyl or acrylate functions); and/or
solid particles, such as silica particles, or nanoparticles.

The impregnating liquid applied to the textile surface may be inert or reactive, i.e. the various components of said impregnating liquid react together to form assemblies and/or networks, especially by crosslinking.

In this respect, mention may be made of the compounds mentioned previously, in a form suitable for such a formation of assemblies and/or networks, for instance functionalized or nonfunctionalized acrylates, in the presence of crosslinking agents that are well known in the field; or particles bearing reactive groups.

The impregnating liquid may especially comprise mutually unreactive compounds, mutually reactive compounds or a mixture of reactive compounds and unreactive compounds.

Preferentially, the impregnating liquid may comprise a silicone-based composition, especially crosslinkable liquid silicone formulations.

There are many crosslinkable liquid silicone formulations that may be used to form a coating that provides functionalities to a large number of textile materials. It is possible to use a wide variety of multi-pack, two-pack or one-pack polyorganosiloxane (POS) compositions that crosslink at room temperature or with heat via polyaddition, hydrosilylation, radical or polycondensation reactions. It should be noted that silicone compositions are fully described in the literature and especially in Walter Noll's “Chemistry and Technology of Silicones”, Academic Press, 1968, 2nd edition, especially pages 386 to 409.

More specifically, the polyorganosiloxanes in the context of a polycondensation or polyaddition reaction, which are the main constituents of the silicone-based composition, are constituted by siloxyl units of general formula:

RnSiO_{(4-n)/2} (I)

and/or of siloxyl units of formula:

ZₓR_{y}SiO_{(4-x-y)/2} (II)

in which formulae the various symbols have the following meaning:
the symbols R, which may be identical or different, each represent a non-hydrolyzable group of hydrocarbon-based nature, this radical possibly being:
   an alkyl or haloalkyl radical containing from 1 to 5 carbon atoms and comprising from 1 to 6 chlorine and/or fluorine atoms,
   cycloalkyl and halocycloalkyl radicals containing from 3 to 8 carbon atoms and from 1 to 4 chlorine and/or fluorine atoms,
   aryl, alkylaryl and haloaryl radicals containing from 6 to 8 carbon atoms and from 1 to 4 chlorine and/or fluorine atoms,
   cyanoalkyl radicals containing from 3 to 4 carbon atoms;
the symbols Z, which may be identical or different, each represent a hydrogen atom, a C₂-C₆ alkenyl group, a hydroxyl group or a hydrolyzable group;
n=an integer equal to 0, 1, 2 or 3;
x=an integer equal to 0, 1, 2 or 3;
y=an integer equal to 0, 1 or 2; and
the sum x+y is between 1 and 3.

Illustrations of organic radicals R, directly bonded to the silicon atoms, which may be mentioned include the following groups: methyl; ethyl; propyl; isopropyl; butyl; isobutyl; n-pentyl; t-butyl; chloromethyl; dichloromethyl; α-chloroethyl; α,β-dichloroethyl; fluoromethyl; difluoromethyl; α,β-difluoroethyl; 3,3,3-trifluoropropyl; trifluorocyclopropyl; 4,4,4-trifluorobutyl; 3,3,4,4,5,5-hexafluoropentyl; β-cyanoethyl; γ-cyanopropyl; phenyl; p-chlorophenyl; m-chlorophenyl; 3,5-dichlorophenyl; trichlorophenyl; tetrachlorophenyl; o-, p- or m-tolyl; α,α,α-trifluorotolyl; xylyls such as 2,3-dimethylphenyl and 3,4-dimethylphenyl. Preferentially, the organic radicals R bonded to the silicon atoms are methyl or phenyl radicals, these radicals possibly being halogenated, or alternatively cyanoalkyl radicals.

The symbols Z may be hydrogen atoms, halogen atoms, in particular chlorine atoms, vinyl or hydroxyl groups, or hydrolyzable groups, for instance: amino, amido, aminoxy, oxime, alkoxy, alkenyloxy, acyloxy.

The nature of the polyorganosiloxane and thus the ratios between the siloxyl units (I) and (II) and the distribution thereof is, as is known, chosen as a function of the crosslinking treatment that will be performed on the curable (or vulcanizable) composition for the purpose of converting it into an elastomer.

The silicone polymer obtained may contain units (R)₃SiO_{1/2} (M); units (R)₂SiO_{2/2} (D), units RSiO_{3/2} (T) and/or units SiO_{4/2} (Q), preferentially at least one unit T or one unit Q.

The two-pack or one-pack polyorganosiloxane compositions that crosslink at room temperature or with heat via polyaddition reactions, essentially by reaction of hydrogenosilyl groups with alkenylsilyl groups, generally in the presence of a metal catalyst, preferably a platinum catalyst, are described, for example, in patents U.S. Pat. No. 3,220,972, U.S. Pat. No. 3,284,406, U.S. Pat. No. 3,436,366, U.S. Pat. No. 3,697,473 and U.S. Pat. No. 4,340,709. The polyorganosiloxanes included in these compositions are generally constituted by couples based, on the one hand, on a linear, branched or crosslinked polysiloxane constituted by units (II) in which the residue Z represents a C₂-C₆ alkenyl group and in which x is at least equal to 1, optionally combined with units (I), and, on the other hand, on a linear, branched or crosslinked hydrogenopolysiloxane constituted by units (II) in which the residue Z then represents a hydrogen atom and in which x is at least equal to 1, optionally combined with units (I).

The two-pack or one-pack polyorganosiloxane compositions that crosslink at room temperature via polycondensation reactions under the action of moisture, generally in the presence of a catalyst, are described, for example, for the one-pack compositions in patents U.S. Pat. No. 3,065,194, U.S. Pat. No. 3,542,901, U.S. Pat. No. 3,779,986 and U.S. Pat. No. 4,417,042, and in patent FR 2 638 752, and, for the two-pack compositions in patents U.S. Pat. No. 3,678,002, U.S. Pat. No. 3,888,815, U.S. Pat. No. 3,933,729 and U.S. Pat. No. 4,064,096. The polyorganosiloxanes included in these compositions are generally linear, branched or crosslinked polysiloxanes constituted by units (II) in which the residue Z is a hydroxyl group, a halogen atom or a hydrolyzable group and in which x is at least equal to 1, with the possibility of having at least one residue Z which is equal to a hydroxyl group, a halogen atom or a hydrolyzable group and at least one residue Z which is equal to an alkenyl group when x is equal to 2 or 3, said units (II) possibly being combined with units (I). Such compositions may also contain a crosslinking agent, which is especially a silane bearing at least two and especially at least three hydrolyzable groups, for instance a silicate, an alkyltrialkoxysilane or an aminoalkyltrialkoxysilane.

The polyorganosiloxane constituents of these compositions that crosslink via polyaddition or polycondensation reactions advantageously have a viscosity at 25° C. of not more than 100 000 mPa·s and preferably between 10 and 50 000 mPa·s.

As polycondensation reaction for the production of a silicone treatment, mention is made especially of the reaction of polyorganosiloxane (POS) resin bearing at least three hydrolyzable/condensable groups of the types OH and/or OR¹ in which R¹ is a linear or branched C₁ to C₆ and preferably C₁ to C₃ alkyl radical; and a polyorganosiloxane (POS) resin bearing at least one hydrolyzable/condensable group of the types OH and/or OR¹ in which R¹ is a linear or branched C₁ to C₆ and preferably C₁ to C₃ alkyl radical, generally in the presence of a polycondensation catalyst that is known in the field (see, for example, patent application FR 2 865 223).

To give the textile surface to be treated a particular property, it is especially possible to use an impregnating liquid comprising a polycondensation-crosslinkable liquid silicone formulation comprising:

A) a silicone network-generating system comprising at least one polyorganosiloxane (POS) resin bearing, per molecule, on the one hand, at least two different siloxyl units chosen from those of the types M, D, T and Q, one of the units being a unit T or a unit Q, and, on the other hand, at least three hydrolyzable/condensable groups of the types OH and/or OR¹, in which R¹ is a linear or branched C₁ to C₆ and preferably C₁ to C₃ alkyl radical;
B) a binding-promoter system, or catalyst especially such as a metal alkoxide or polyalkoxide of Ti, Zr, Ge, Si, Mn or Al, such as titanates, zirconates and/or silicates, especially n-propyl (Pr) zirconate of formula Zr(OPr)₄, n-butyl (Bu) titanate of formula Ti(OBu)₄ and ethyl (Et) silicate of formula Si(OEt)₄;
C) a functional additive of the type such as a silane, polyorganosiloxane or organic compound, which is essentially linear; each of these compounds comprising:
one or more binding functions capable of reacting with A) and/or B) or capable of generating in situ functions capable of reacting with A) and/or B), such as condensable/hydrolyzable functions corresponding to OH and/or OR¹ or functions capable of generating in situ OH and/or OR¹ functions;
one or more functions capable of giving the textile surface to be treated a particular property, for instance:
hydrophobicity, these functions may bear alkyl groups, silicone groups and/or fluoro groups; and/or
hydrophilicity, these functions may bear amine, amide, hydroxyl and/or polyether groups.

The crosslinkable liquid silicone formulation may comprise, per 100 parts by weight of constituent A), from 0.5 to 200, preferably from 0.5 to 100 and more preferably from 1 to 70 parts of constituent B), and from 1 to 1000 and preferably from 1 to 300 parts of constituent C).

A silicone composition that is especially preferred is one obtained by mixing the various compositions:
composition A comprising at least one polyorganosiloxane (POS) resin bearing, per molecule, on the one hand, at least two different siloxyl units chosen from those of the types M, D, T and Q, one of the units being a unit T or a unit Q, and, on the other hand, at least three hydrolyzable/condensable groups of the types OH and/or OR¹ in which R¹ is a linear or branched C₁ to C₆ and preferably C₁ to C₃ alkyl radical; this composition preferentially being a mixture of a hydroxylated MDT resin, optionally comprising units CH₃SiO_{3/2} (T), units (CH₃)₂SiO_{2/2} (D) and units (CH₃)₃SiO_{1/2} (M); and a hydroxylated MQ resin, optionally comprising units SiO_{4/2} (Q) and units (CH₃)₃SiO_{1/2} (M);
composition B comprising a catalyst, especially such as a metal alkoxide or polyalkoxide of Ti, Zr, Ge, Si, Mn or Al, such as titanates, zirconates and/or silicates, especially n-propyl (Pr) zirconate of formula Zr(OPr)₄, n-butyl (Bu) titanate of formula Ti(OBu)₄ and ethyl (Et) silicate of formula Si(OEt)₄;
composition C comprising a hydroxylated MDT resin optionally comprising units CH₃SiO_{3/2} (T), units (CH₃)₂SiO_{2/2} (D) and units (CH₃)₃SiO_{1/2} (M) and a hydroxylated silicone gum (units D) optionally comprising units (CH₃)₂SiO_{2/2} (D);
a diluent, which may be an aqueous phase supplemented with surfactant, or an organic solvent, especially aliphatic, chlorinated, aromatic, alkanol or carboxylic acid ester solvents.

The silicone composition may optionally comprise one or more other compounds taken from the group especially comprising: reinforcing or semireinforcing or stuffing fillers or fillers that serve to adapt the rheology of thermosetting compositions, crosslinking agents, adhesion agents, plasticizers, catalyst inhibitors and coloring agents.

After the impregnation process of the invention, the textile surface may be brought to a means allowing better penetration of the impregnating liquid and/or serving to uniformly apply said liquid onto the textile surface. To this end, it is possible to use one or more doctor blades, or expressing rolls, such as those conventionally used for pad finishing. A doctor blade is preferred due to its static nature.

Depending on the impregnating liquids used in the process according to the invention, it may be necessary to dry the impregnated textile surface to extract the solvents therefrom, to accelerate the textile surface finishing process, to increase the penetration of the impregnating liquid into the textile surface, or to initiate possible chemical reactions, for instance a crosslinking or a polymerization. To this end, the impregnated textile surface may be brought to a drying means, for instance those conventionally used in pad finishing processes. To do this, it is especially possible to use a ventilated drying oven, a drying device under electromagnetic radiation (infrared or microwave), a high-frequency drying device, or a festoon dryer.

Besides the impregnation process according to the present invention, the textile surface may undergo one or more other subsequent treatments, also known as finishing or dry-filling treatments. These other treatments may be performed before, after and/or during said impregnation process of the invention. As other subsequent treatments, mention may be made especially of: printing, calendering, flaming or grilling, desizing, laminating, coating, assembly with other materials or textile surfaces, washing, degreasing, carbonizing, embossing, blistering, moireing, scraping, fulling, decating, chlorinating, covering, sanforizing, preforming or fixing.

The textile surfaces, in native form or transformed into textile articles, may be used in numerous applications, for instance in the field of clothing, household articles, building and public works, hygiene articles, interior or exterior textile architecture, such as tarpaulins, tents, stands and marquees, and the industrial sector. In the latter sector, mention may be made of filtration, coating supports, motor vehicle construction, the food industry, the papermaking industry or the mechanical industry.

A subject of the present invention is also a device for performing the process defined previously, comprising at least:
a fixed, hollow cylinder comprising orifices on the contact surface between the cylinder and the textile surface;
a means for bringing the textile surface to the cylinder;
optionally a means for increasing the penetration of the impregnating liquid and/or serving to apply said liquid uniformly onto the textile surface; and
optionally a means for drying the textile surface after said impregnation.

In the process of the invention, it is obvious that the flow rate of the impregnating liquid and the throughput speed of the textile surface on the perforated cylinder will be adapted as a function of the nature of the impregnating fluid and of the amount to be dispensed per unit area. It is entirely possible for the process of the invention and especially the adjustment of the flow rate of the impregnating liquid and of the throughput speed of the textile surface on the perforated cylinder to be controlled and executed by instructions coming from a computer loaded with suitable software.

The present invention thus relates to a computer program for implementing the process and/or the device described previously, which may be loaded directly into the internal memory of a digital computer comprising at least software code portions for controlling the adjustment of the flow rate of the impregnating liquid and the throughput speed of the textile surface on the perforated cylinder, when said program is run on a computer.

Specific language is used in the description so as to facilitate the understanding of the principle of the invention. It should however be understood that no limitation of the scope of the invention is envisioned by the use of this specific language. Modifications, improvements and enhancements may especially be envisioned by a person skilled in the art on the basis of his general knowledge. The term “and/or” includes the meanings “and”, “or” and also all the other possible combinations of elements connected with this term.

Other details or advantages of the invention will emerge more clearly in the light of the examples given below, purely for indicative purposes.

### EXPERIMENTAL SECTION

### Example 1

### Monolayer Textile Surface

The textile surface used is a polyamide fabric made from a polyamide 6.6 yarn of 78 dtex/68 ends used in warp and in weft. This fabric has an overall width of 150 cm and a mass per unit area of about 100 g/m².

The treatment applied is a water-repellency treatment based on a crosslinkable liquid silicone formulation. The composition used comprises the following constituents (the parts are given on a weight basis):
A: mixture of:
   hydroxylated MDT resin containing 0.5% by weight of OH and constituted of 62% by weight of units CH₃SiO_{3/2}, 24% by weight of units (CH₃)₂SiO_{2/2} and 14% by weight of units (CH₃)₃SiO_{1/2}: 47 parts; and
   hydroxylated MQ resin containing 2% by weight of OH and constituted of 45% by weight of units SiO_{4/2} and 55% by weight of units (CH₃)₃SiO_{1/2}: 7 parts;
B: mixture of:
   tris(3-(trimethoxysilyl)propyl)isocyanurate: 7 parts
   n-propyl (Pr) zirconate of formula Zr(OPr)₄: 20 parts
   n-butyl (Bu) titanate of formula Ti(OBu)₄: 2 parts; and
   ethyl (Et) silicate of formula Si(OEt)₄: 4 parts;
C: mixture of:
   hydroxylated MDT resin containing 0.5% by weight of OH and constituted of 62% by weight of units CH₃SiO_{3/2}, 24% by weight of units (CH₃)₂SiO_{2/2} and 14% by weight of units (CH₃)₃SiO_{1/2}: 10 parts; and
   hydroxylated silicone gum (unit D) containing about 0.01% by weight of OH and constituted of 100% by weight of units (CH₃)₂SiO_{2/2}: 20 parts;
D: white spirit solvent: 883 parts.

The composition is rediluted in solvent (white spirit) before application, so as to bring its active material content to 5%. Its dynamic viscosity at such a concentration is 4 mPa·s. This type of treatment, for crosslinking via a polycondensation reaction, is sensitive to exposure to atmospheric moisture. Prolonged exposure to atmospheric moisture will have as a consequence the formation of gels and of whitish lumps.

By way of comparison, the techniques of pad finishing and of kiss roll impregnation were used to treat the textile surface described above with the water-repellency treatment also described above.

The technique that is the subject of the present invention was itself used with the following parameters: stainless-steel 316 cylinder, diameter 32 mm, length 1600 mm, mean diameter of the orifices of the perforated cylinder=0.5 mm and distance between the orifices=1 mm (center to center), i.e. a ratio L of 1.

The target throughput speed of the textile was 5 m/minute and the target degree of wet uptake (weight of solution taken up per unit weight of textile) onto the textile surface was 80%.

The treatment composition is brought into the tube by means of a standard peristaltic pump (such as a MasterFlex LS) capable of output in the range 1-3 l/minute.

The penetration of the treatment composition into the textile is promoted by using a small downstream cylinder (component 9 of FIG. 4), of diameter 30 mm and length 1600 mm.

The textile surface then passes through an oven at a temperature of about 150° C. The passage time is about 2 minutes.

Measurement of the pearling effect is performed by means of the standard water-repellency test known as the Spray Test (AATC Test Method 22-1996): this test consists in spraying the sample of the textile article with a given volume of water. The appearance of the sample is then evaluated visually and compared with standards. A note from 0 to 5 is attributed as a function of the amount of water retained. For 0, the sample is totally moistened, for 5, the sample is completely dry.

To test the durability of the treatment, an industrial washing machine of Washcator type (Electrolux) was used for continuous washing at 50° C. for variable times of 8, 16, 24, 32, 40 and 48 hours.

The Spray Test measurement is taken before and after washing.

Table 1 below collates the results obtained using the three impregnation techniques:

TABLE 1

| | | | | Quality of the water-repellency treatment: | | |
|---|---|---|---|---|---|---|
| | | | | | | Spray test |
| Impregnation process: | | | | | Spray test | (after 8 hours |
| Type | Wet uptake | Foaming | Homogeneity | Appearance | (new state) | of washing) |
| Padding | Compliant | Average | Excellent | Stains after | 5 | 4-5 |
| | | | | prolonged | | |
| | | | | functioning | | |
| Kiss roll | Insufficient (*) | Low | Heterogeneous | Treatment defects | 4-5 | <3 |
| | | | | Stains after | (heterogeneous | |
| | | | | prolonged | depending on | |
| | | | | functioning | the sampling) | |
| Invention | Compliant | None | Excellent | Excellent | 5 | 4-5 |

(*) irrespective of the speed adjustment conditions of the kiss roll

This table clearly shows that the perforated tube technique makes it possible to obtain the best performance qualities for the water-repellency treatment.

### Example 2

### Multilayer Textile Surface

The textile surface used is a laminated 3-layer complex based on an outer polyamide fabric (100 g/m²), a hydrophilic polyurethane membrane and a polar polyester (130 g/m²). The outer layer of this laminate intended to receive the water-repellency treatment is based on a polyamide 6.6 yarn of 78 dtex/68 ends used in warp and in weft. This fabric has an overall width of 150 cm and a mass per unit area of about 100 g/m².

The treatment applied is a water-repellency treatment based on a crosslinkable liquid silicone formulation already described previously.

For comparative purposes, the kiss roll impregnation technique was used to treat the textile surface described above with the water-repellencOy treatment also described above. The pad finishing technique could not be used since, to respect the functionality of the complex (moisture transfer), the inner layer should not be treated.

The cylinder is the same as that used in example 1.

The target textile throughput speed was 5 m/minute and the target degree of wet uptake on the textile surface was 80%.

Table 2 below collates the results obtained using the two impregnation techniques:

TABLE 2

| | | | | Quality of the water-repellency treatment: | | |
|---|---|---|---|---|---|---|
| | | | | | | Spray test |
| Impregnation process: | | | | | Spray test | (after 8 hours |
| Type | Wet uptake | Foaming | Homogeneity | Appearance | (new state) | of washing) |
| Kiss roll | Insufficient (*) | Low | Heterogeneous | Treatment defects | 4-5 | <3 |
| | | | | Stains after | (heterogeneous | |
| | | | | prolonged | depending on | |
| | | | | functioning | the sampling) | |
| Invention | Compliant | None | Excellent | Excellent | 5 | 4-5 |

(*) irrespective of the speed adjustment conditions of the kiss roll

In this example also, this table clearly shows that the perforated tube technique makes it possible to obtain the best performance qualities for the water-repellency treatment.

1. A process for impregnating a textile surface comprising bringing said textile surface into contact with at least one fixed, hollow cylinder that dispenses an impregnating liquid by means of orifices that are, present on a contact surface between the cylinder and the textile surface, so as to impregnate said textile surface on one face thereof.

2. The process as claimed in claim 1, wherein the textile surface is a monolayer or multilayer surface.

3. The process as claimed in claim 1, wherein said cylinder has a diameter of 5 to 200 mm.

4. The process as claimed in claim 1, wherein said cylinder comprises orifices only in a region of contact with said textile surface.

5. The process as claimed in claim 1, wherein the mean diameter of the orifices of the cylinder is from 0.05 to 5 mm.

6. The process as claimed in claim 1, wherein the orifices are arranged on the contact surface of the cylinder, randomly, in one or more parallel lines over the length of the cylinder, and/or in zig zags.

7. The process as claimed in claim 1, wherein spacing and positioning of the orifices of the cylinder are such that total impregnation of the textile surface is obtained when said textile surface passes over a surface of said cylinder, taking into account diffusability of the impregnating liquid on the textile surface.

8. The process as claimed in claim 1, wherein the spacing between the orifices of the cylinder obeys the following relationship: 0.1≦L≦10, with L corresponding to a ratio between i) total theoretical length of orifices that are arranged next to each other over a length of the cylinder; and ii) the length of the cylinder.

9. The process as claimed in claim 1, wherein the process comprises a means for bringing the impregnating liquid into the cylinder.

10. The process as claimed in claim 1, wherein the impregnating liquid comprises at least one agent selected from the group consisting of:
dyeing agents,
bleaching agents,
glazing agents,
mercerizing agents,
impermeabilizing and water-repellent agents,
flame retardants,
stain removers,
antibacterial, antifungal and/or anti-acarian agents,
water-repellency agents, and
softeners.

11. The process as claimed in claim 1, wherein the impregnating liquid has a dynamic viscosity of between 0.1 and 1000 and preferentially between 0.5 and 50.

12. The process as claimed in claim 1, wherein the impregnating liquid comprises a silicone-based composition.

13. The process as claimed in claim 1, wherein the impregnating liquid comprises a multi-pack, two-pack or one-pack polyorganosiloxane composition that crosslinks at room temperature or with heat via polyaddition, hydrosilylation, radical and/or a condensation reaction.

14. The process as claimed in claim 1, wherein said process comprises a means for bringing the textile surface into contact with said cylinder.

15. The process as claimed in claim 1, wherein the process comprises at least one means that allows penetration of the impregnating liquid and/or serves to uniformly apply said liquid onto the textile surface.

16. The process as claimed in claim 1, wherein the process comprises a means for drying the textile surface after said impregnation.

17. An article that may be obtained via the process as described in claim 1.

18. The article as claimed in claim 17, which is at least one selected from the group consisting of: clothing, household articles, building and public works, hygiene articles, interior or exterior textile architectures, and the industrial sector articles.

19. A device capable of implementing a process for impregnating a textile surface as defined in claim 1, comprising:
a fixed, hollow cylinder comprising at least orifices on a contact surface between the cylinder and a textile surface;
a means for bringing the textile surface to the cylinder;
optionally a means for increasing the penetration of the impregnating liquid and/or serving to apply said liquid uniformly onto the textile surface; and
optionally a means for drying the textile surface after said impregnation.

20. A computer program capable of implementing a process as claimed in claim 1, which may be loaded directly into an internal memory of a digital computer, said program comprising at least software code portions for controlling adjustment of flow rate of the impregnating liquid and the throughput speed of the textile surface on the cylinder, when said program is run on a computer.
